(19) United States
(12) Patent Application Publication
(10) Pub. No.: US 2018/0250865 A1
(43) Pub. Date: Sep. 6, 2018

(54) FILM PRODUCING APPARATUS AND METHOD OF PRODUCING FILM

(71) Applicant: Sumitomo Chemical Company, Limited, Tokyo (JP)

(72) Inventors: Takuya AKIYAMA, Niihama-shi (JP); Jun MIZOTA, Niihama-shi (JP)

(21) Appl. No.: 15/909,985

(22) Filed: Mar. 1, 2018

(30) Foreign Application Priority Data
Mar. 3, 2017 (JP) 2017-041080

(51) Int. Cl. B29C 47/08; B29C 47/00; B29C 47/60

(52) U.S. Cl. CPC B29C 47/0896; B29C 2791/003; B29C 47/60; B29C 47/0021

(57) ABSTRACT

The present invention provides a film producing apparatus and a method of producing a film both of which reduce the cost of producing a film. A film producing apparatus includes a first plasticizer collecting section and a second plasticizer collecting section each of which collects a portion of a film-forming plasticizer which portion has been separated from the film.

This Nonprovisional application claims priority under 35 U.S.C. § 119 on Patent Application No. 2017-041080 filed in Japan on Mar. 3, 2017, the entire contents of which is hereby incorporated by reference.

### TECHNICAL FIELD

The present invention relates to a film producing apparatus and a film producing method both of which form a film in a form of a sheet by kneading a polyolefin resin and a film-forming plasticizer to prepare a polyolefin resin solution, and then performing extrusion molding of the polyolefin resin solution thus prepared.

### BACKGROUND ART

Nonaqueous electrolyte secondary batteries such as a lithium-ion secondary battery are in widespread use as batteries for a personal computer, a mobile telephone, a portable information terminal, an electric vehicle, and others. Attention is paid to, in particular, the lithium-ion secondary battery because the lithium-ion secondary battery has a higher energy density, emits less carbon dioxide, and makes a greater contribution to energy saving than a conventional secondary battery. Under the circumstances, the demand for the lithium-ion secondary battery has grown greatly. To meet this demand, it has been required to reduce the costs of producing the lithium-ion secondary battery and a separator for the nonaqueous electrolyte secondary battery (hereinafter referred to as a “nonaqueous electrolyte secondary battery separator”).

The so-called wet film forming method is known as a technique for producing the nonaqueous electrolyte secondary battery separator and other films. According to the wet film forming method, a film in a form of a sheet is formed by kneading a polyolefin resin and a liquid paraffin (film-forming plasticizer) to prepare a polyolefin resin solution, and then performing extrusion molding of the polyolefin resin solution thus prepared.

Patent Literature 1 discloses a technique of cleaning the film to remove a liquid paraffin from the film.

### CITATION LIST

### Patent Literature

[Patent Literature 1] Japanese Patent Application Publication, Tokukai, No. 2014-102882 (Publication Date: Jun. 5, 2014)

### SUMMARY OF INVENTION

### Technical Problem

A liquid paraffin is relatively expensive. Thus, it is considered that the cost of producing a film can be reduced by collecting and reusing a liquid paraffin.

In view of this, the inventors of the present application studied on an increase in rate of collection of a used liquid paraffin and found that there is a situation in which a liquid paraffin separates on its own from a film before cleaning of the film. That is, the inventors of the present application found that during conveyance of a film having been formed by extrusion molding into a cleaning tank, a liquid paraffin can separate on its own from the film.

The present invention has been made in view of the above problem, and it is an object of the present invention to provide a film producing apparatus and a film producing method both of which enable reduction in cost of producing a film.

### Solution to Problem

In order to achieve the above object, a film producing apparatus in accordance with an aspect of the present invention includes: a kneading section configured to knead a polyolefin resin and a film-forming plasticizer to prepare a polyolefin resin solution; an extruding section configured to perform extrusion molding of the polyolefin resin solution thus prepared to form a film in a form of a sheet; and at least one plasticizer collecting section configured to collect a portion of the film-forming plasticizer which portion has been separated from the film.

Further, in order to achieve the above object, a method of producing a film in accordance with an aspect of the present invention includes: a first kneading step including kneading a first polyolefin resin and a first film-forming plasticizer to prepare a first polyolefin resin solution; an extruding step including performing extrusion molding of the first polyolefin resin solution thus prepared to form a film in a form of a sheet; and a plasticizer collecting step including collecting a portion of the first film-forming plasticizer which portion has been separated from the film.

The above configuration allows for collection of a portion of a film-forming plasticizer which portion has been separated from a film. This makes it possible to increase a rate of collection of a used film-forming plasticizer. Consequently, the cost of producing a film can be reduced by reusing the film-forming plasticizer.

### Advantageous Effects of Invention

The present invention enables reduction in cost of producing a film.

### BRIEF DESCRIPTION OF DRAWINGS

FIG. 1 is a schematic diagram illustrating the configuration of a film producing apparatus in accordance with an embodiment of the present invention.

FIG. 2 is a diagram transparently illustrating the insides of two kneading chambers.

FIG. 3 is a schematic diagram illustrating an example of a modification made to the configuration illustrated in FIG. 2.

FIG. 4 is a graph showing an example of weight ratios between polyethylene and a liquid paraffin in a polyethylene resin solution.

FIG. 5 is a schematic diagram illustrating another example of a first plasticizer collecting section.

(a) and (b) of FIG. 6 are schematic diagrams illustrating other examples of a plasticizer separating section.

FIG. 7 is a schematic diagram illustrating another example of the plasticizer separating section.

### DESCRIPTION OF EMBODIMENTS

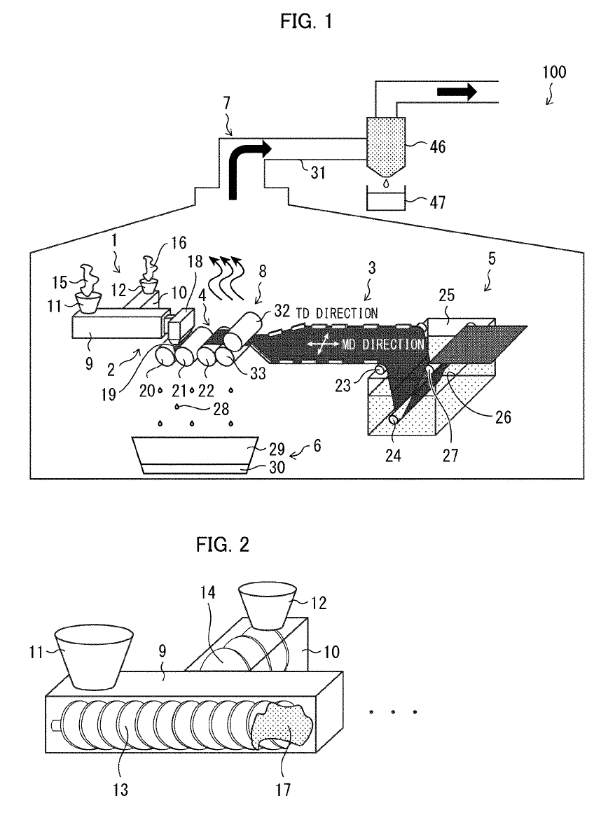

Embodiments for carrying out the present invention will be discussed below with reference to FIGS. 1 to 7.

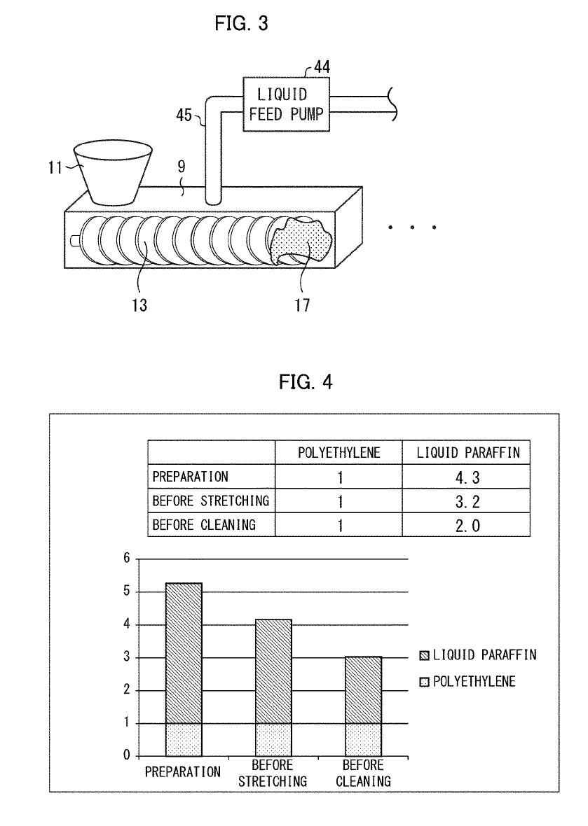

FIG. 1 is a schematic diagram illustrating the configuration of a film producing apparatus 100 in accordance with an embodiment of the present invention. FIG. 2 is a diagram transparently illustrating the insides of kneading chambers 9 and 10, which are provided in the film producing apparatus 100. FIG. 3 is a schematic diagram illustrating an example of a modification made to the configuration illustrated in FIG. 2.

The film producing apparatus 100 includes a kneading section 1, an extruding section 2, a stretching section 3, a conveying section 4, a cleaning section 5, a first plasticizer collecting section 6, a second plasticizer collecting section 7, and a plasticizer separating section 8.

The kneading section 1 includes a kneading chamber 9, a kneading chamber 10, a polyolefin resin feed opening 11, a film-forming plasticizer feed opening 12, a screw 13, and a screw 14. Further, the kneading chamber 9 and the kneading chamber 10 are connected to each other.

When the polyolefin resin 15 is fed into the polyolefin resin feed opening 11, the polyolefin resin 15 enters the kneading chamber 9. Examples of the polyolefin resin 15 include polyethylene. Meanwhile, when the film-forming plasticizer (first film-forming plasticizer) 16 is fed into the film-forming plasticizer feed opening 12, the film-forming plasticizer 16 enters the kneading chamber 10. Alternatively, the film-forming plasticizer 16 can enter both the kneading chamber 9 and the kneading chamber 10 through both the polyolefin resin feed opening 11 and the film-forming plasticizer feed opening 12.

Further alternatively, in a case where the film-forming plasticizer 16 is in the form of a liquid at normal temperature, the film-forming plasticizer 16 can be fed into the kneading chamber 9 through the use of a liquid feed pump 44 and a liquid feed pipe 45 as illustrated in FIG. 3, rather than through the use of the kneading chamber 10, the film-forming plasticizer feed opening 12, and the screw 14.

Examples of the film-forming plasticizer 16 in the form of a liquid at normal temperature include: liquid paraffin; phthalate esters such as dibutyl phthalate, bis(2-ethylhexyl) phthalate, dioctyl phthalate, and dinonyl phthalate; and unsaturated higher alcohols such as oleyl alcohol. Examples of the film-forming plasticizer 16 in the form of a solid at normal temperature include: paraffin wax; and saturated higher alcohols such as stearyl alcohol.

The screw 14 kneads the film-forming plasticizer 16 having entered the kneading chamber 10, and extrudes the film-forming plasticizer 16 from the kneading chamber 10 to the kneading chamber 9. The screw 13 kneads (i) the polyolefin resin 15 having entered the kneading chamber 9 and (ii) the film-forming plasticizer 16 having been extruded from the kneading chamber 10 to the kneading chamber 9, so that a polyolefin resin solution (first polyolefin resin solution) 17 is prepared (first kneading step).

The extruding section 2 includes the screw 13 and a die 18. The extruding section 2 performs, through the use of the die 18, extrusion molding of the polyolefin resin solution 17 having been extruded from the kneading chamber 9 by the screw 13, so as to form a film 19 in the form of a sheet (extruding step). Using the die 18 is merely an example. As alternatives to the die 18, various kinds of devices capable of performing extrusion molding of the polyolefin resin solution 17 can be used.

The stretching section 3 stretches the film 19 in a machine direction (MD; also referred to as MD direction) and in a transverse direction (TD; also referred to as TD direction) (stretching step). The MD direction, which is a lengthwise direction of the film 19, is a direction of the flow of the film 19 during the production through the use of the film producing apparatus 100. The TD direction is a direction perpendicular to the MD direction.

The conveying section 4 includes a roller 20, a roller 21, a roller 22, a roller 23, and a roller 24. The conveying section 4 conveys the film 19 so that the film 19 passes through the extruding section 2, the stretching section 3, and the cleaning section 5 in this order (conveying step).

The cleaning section 5 includes a cleaning tank 25. The cleaning tank 25 is filled with a cleaning liquid 26. Examples of the cleaning liquid 26 include: hydrocarbons such as pentane, hexane, and heptane; alcohols such as methanol, ethanol, and isopropanol; ketones such as acetone and methyl ethyl ketone; and chlorine-based hydrocarbons such as methylene chloride and 1,1,1-trichloroethan. The film 19 having been stretched by the stretching section 3 enters the cleaning section 5 and is then immersed in the cleaning liquid 26. The film 19 is cleaned by being immersed in the cleaning liquid 26 (cleaning step). This cleaning removes a portion of the film-forming plasticizer 16 which portion has adhered to the film 19. The film 19 having been cleaned passes through a roller 27, thereby being pulled out of the cleaning liquid 26 and then being gotten out of the cleaning section 5.

By the way, the film 19 having been formed by the extruding section 2 has a high temperature. Such a high-temperature film 19 is cooled in the process of passing through the roller 20, the roller 21, and the roller 22. The cooling causes phase separation between the polyolefin resin 15 and the film-forming plasticizer 16 both of which have been dissolved with each other, thereby forming a microporous structure having a skeleton of the polyolefin resin 15. The cooling separates, from the film 19, a certain amount of portion of the film-forming plasticizer 16 contained in the film 19. Specifically, a certain amount of portion of the film-forming plasticizer 16 contained in the film 19 is dripped from the film 19. In FIG. 1, a portion of the film-forming plasticizer 16 which portion has been dripped from the film 19 corresponds to drops 28. Moreover, the film 19 having been formed by kneading in the extruding section 2 and extrusion through the die 18 has a high temperature. Thus, a portion of the film-forming plasticizer 16 contained in the film 19 is volatilized from the film 19.

The first plasticizer collecting section 6 includes a container 29 for receiving the drops 28. The first plasticizer collecting section 6 causes the container 29 to receive the drops 28, thereby collecting a portion of the film-forming plasticizer 16 which portion has been dripped from the film 19 (plasticizer collecting step). In FIG. 1, a liquid 30 stored in the container 29 is the drops 28 collected and obtained by the container 29.

The container 29 is preferably provided immediately below the area where the film 19 is cooled. As described previously, during cooling of the film 19, a large amount of portion of the film-forming plasticizer 16 is dripped from the film 19. Providing the container 29 immediately below the area where the film 19 is cooled allows the film-forming plasticizer 16 to be received immediately below the film 19 being cooled. This achieves an adequately high rate of collection of a used film-forming plasticizer 16.

Further, the container 29 is preferably provided immediately below the plasticizer separating section 8, which will be described later. As described later, during separation of the film-forming plasticizer 16 from the film 19, a large amount of portion of the film-forming plasticizer 16 is dripped from the film 19. Providing the container 29 immediately below the plasticizer separating section 8 achieves an adequately high rate of collection of a used film-forming plasticizer 16.

Providing the first plasticizer collecting section 6 enables collection of a portion of the film-forming plasticizer 16 which portion has been dripped from the film 19. This makes it possible to increase a rate of collection of a used film-forming plasticizer 16. Consequently, the cost of producing the film 19 can be reduced by reusing the film-forming plasticizer 16. Note that the collected film-forming plasticizer 16 can be purified for reuse if necessary.

The second plasticizer collecting section 7 includes: a suction port 31 for suctioning a gas containing a portion of the film-forming plasticizer 16 which portion has been volatilized from the film 19; a liquefying device (the so-called condenser) 46 provided in the passage of the suction port 31; and a container 47 provided in a position where the film-forming plasticizer 16 having been liquefied by the liquefying device 46 is received. The liquefying device 46 is configured by, for example, an electrostatic precipitation mist collector, a filter mist collector, or a centrifugal mist collector. The liquefying device 46 is preferably provided in an atmosphere where a temperature is adjusted to an optimum temperature for producing the film 19 (e.g., in a clean room where the film producing apparatus 100 is installed). In the second plasticizer collecting section 7, the suction port 31, the liquefying device 46, and the container 47 collect a portion of the film-forming plasticizer 16 which portion has been volatilized from the film 19 (plasticizer collecting step). The gas having been suctioned through the suction port 31 passes through the liquefying device 46. Thereafter, the gas may be discharged out of the film producing apparatus 100 or may be returned to the film producing apparatus 100. The suction port 31 can also be referred to as an outlet. Note, however, that the liquefying device 46 is not necessary in a case where the volatilized portion of the film-forming plasticizer from the film 19 can be naturally liquefied by an atmosphere surrounding the volatilized portion of the film-forming plasticizer 16. In this case, a portion of the film-forming plasticizer 16 which portion has been liquefied by, for example, a ramp in the passage of the suction port 31 is collected.

Providing the second plasticizer collecting section 7 enables collection of a portion of the film-forming plasticizer 16 which portion has been volatilized from the film 19. This makes it possible to increase a rate of collection of a used film-forming plasticizer 16. Consequently, the cost of producing the film 19 can be reduced by reusing the film-forming plasticizer 16. Note that the collected film-forming plasticizer 16 may be purified for reuse if necessary.

The plasticizer separating section 8 includes a nip roller 32 and a nip roller 33 between which the film 19 is sandwiched. The nip roller 32 and the nip roller 33 are provided at a stage previous to the stretching section 3 (at a stage previous to the cleaning section) and at a stage subsequent to the roller 22. The nip roller 32 can slide one surface of the film 19 without rotating. The nip roller 33 can slide another surface of the film 19 without rotating. The nip roller 32 and the nip roller 33 sandwich the film 19 therebetween, thereby dropping a portion of the film-forming plasticizer 16 from the film 19. In the plasticizer separating section 8, the nip rollers 32 and 33 separate a portion of the film-forming plasticizer 16 from the film 19 at the stage previous to the stretching section 3 (plasticizer separating step).

Providing the plasticizer separating section 8 to separate a portion of the film-forming plasticizer 16 from the film 19 before cleaning of the film 19 enables preventing the occurrence of a situation in which the film-forming plasticizer 16 having adhered to the film 19 hinders cleaning of the film 19.

Providing the plasticizer separating section 8 to separate a portion of the film-forming plasticizer 16 from the film 19 before cleaning of the film 19 also eliminates the need to extract a portion of the film-forming plasticizer 16 which portion has been mixed into the cleaning liquid 26 in the cleaning tank 25 or enables the mixed portion of the film-forming plasticizer 16 to be extracted with a light load.

Thus, providing the plasticizer separating section 8 allows for improvement in efficiency of producing the film 19.

Note that the nip rollers 32 and 33 may each be replaced by a blade, an air knife, or other component that can slide the film 19 to drop a portion of the film-forming plasticizer 16 from the film 19. In other words, even replacing the nip roller 32 by a blade or an air knife and/or replacing the nip roller 33 by a blade or an air knife can achieve a function that is much the same as the function of the plasticizer separating section 8.

Stretching of the film 19 by the stretching section 3 requires a certain amount of plasticizer for evenly stretching the film 19. Thus, it is effective that before the film 19 enters the stretching section 3, a portion of the film-forming plasticizer 16 is separated from the film 19 to such an extent that the stretching section 3 does not become excessively contaminated with a retained portion of the film-forming plasticizer 16 in the film 19, and then, before the film 19 enters the cleaning section 5, another portion of the film-forming plasticizer 16 in the film 19 is further separated.

The plasticizer separating section 8 separates a portion of the film-forming plasticizer 16 from the film 19, so that the conveying section 4 causes the film 19 to enter the stretching section 3 in a state in which the amount of film-forming plasticizer 16 contained in the film 19 is decreased by not less than 10% to not more than 40% relative to the amount of film-forming plasticizer 16 contained in the polyolefin resin solution 17 which is equal in volume to the film 19.

The plasticizer separating section 8 separates a portion of the film-forming plasticizer 16 from the film 19, so that the conveying section 4 causes the film 19 to enter the cleaning section 5 in a state in which the amount of film-forming plasticizer 16 contained in the film 19 is decreased by not less than 30% to not more than 70% relative to the amount of film-forming plasticizer 16 contained in the polyolefin resin solution 17 which is equal in volume to the film 19. Note, however, that a decreased amount resulting from the not less than 30% to not more than 70% decrease will be larger than that resulting from the not less than 10% to not more than 40% decrease. In other words, the amount of film-forming plasticizer 16 contained in the film 19 at the entry into the stretching section 3 is larger than the amount of film-forming plasticizer 16 contained in the film 19 at the entry into the cleaning section 5.

FIG. 4 is a graph showing an example of weight ratios between polyethylene as an example of the polyolefin resin 15 and a liquid paraffin as an example of the film-forming plasticizer 16, in a polyethylene resin solution as an example of the polyolefin resin solution 17. Specifically, FIG. 4 shows weight ratios obtained when the weight of polyethylene is assumed to be 1. In the graph shown in FIG. 4, “PREPARATION” indicates a timing when kneading of polyethylene and liquid paraffin is completed. Further, in the graph shown in FIG. 4, “BEFORE STRETCHING” indicates a timing immediately before the film 19 enters the stretching section 3. Still further, in the graph shown in FIG. 4, “BEFORE CLEANING” indicates a timing immediately before the film 19 enters the cleaning section 5.

A small amount of film-forming plasticizer 16 contained in the film 19 at the start of cleaning of the film 19 can prevent the occurrence of a situation in which the film-forming plasticizer 16 having adhered to the film 19 hinders cleaning of the film 19.

A small amount of film-forming plasticizer 16 contained in the film 19 at the start of cleaning of the film 19 also eliminates the need to extract a portion of the film-forming plasticizer 16 which portion has been mixed into the cleaning liquid 26 in the cleaning tank 25 or enables the mixed portion of the film-forming plasticizer 16 to be very easily extracted with a light load.

This enables improvement in efficiency of producing the film 19.

The film producing apparatus 100 uses the plasticizer separating section 8 to bring about a state in which a desired amount of film-forming plasticizer 16 is contained in the film 19. However, using the plasticizer separating section 8 is not always a requirement to bring about such a state. For example, the plasticizer separating section 8 can be omitted in the film producing apparatus 100, provided that such a state is achieved by dripping or volatilization of a portion of the film-forming plasticizer 16 from the film 19 or by heating of the film 19 in the stretching section 3.

Examples of a finished product that includes a film produced by the film producing apparatus 100 include a nonaqueous electrolyte secondary battery separator. However, an application for which the film producing apparatus 100 is used is not limited to the production of a nonaqueous electrolyte secondary battery separator. The film producing apparatus 100 can also serve as apparatuses for producing various films that can be produced by a wet film forming method.

Portions of the film-forming plasticizer 16 which portions have been collected by the first plasticizer collecting section 6 and by the second plasticizer collecting section 7 are made available for reuse. Specifically, the kneading section 1 kneads a polyolefin resin 15 or other polyolefin resin which is different from the polyolefin resin 15, the collected portions of the film-forming plasticizer 16, and a separately prepared film-forming plasticizer (second film-forming plasticizer). Through the kneading, the kneading section 1 prepares a polyolefin resin solution (second polyolefin resin solution) (second kneading step). The cost of producing the film 19 can be reduced by reusing the film-forming plasticizer 16.

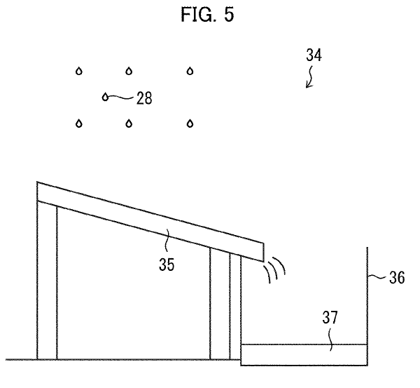

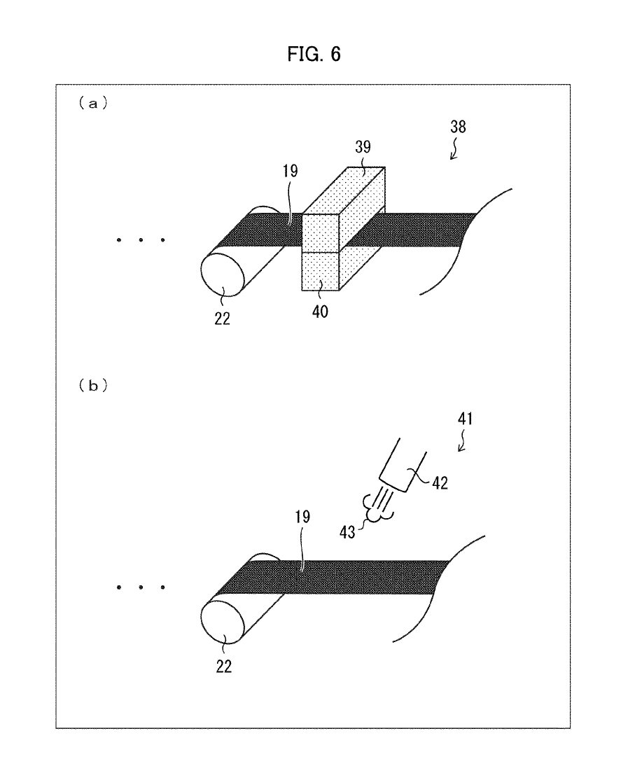

FIG. 5 is a schematic diagram illustrating a first plasticizer collecting section 34.

The first plasticizer collecting section 34 illustrated in FIG. 5 is different from the first plasticizer collecting section 6 illustrated in FIG. 1 in the following points. Specifically, the first plasticizer collecting section 34 includes a liquid receiving member 35 for receiving drops 28; and a container 36 provided in such a position that a portion of the film-forming plasticizer 16 is flown into the container 36 through the liquid receiving member 35. In FIG. 5, a liquid 37 stored in the container 36 is the drops 28 collected and obtained by the container 36. The liquid receiving member 35 is preferably arranged in a tilted position so as to allow a portion of the film-forming plasticizer 16 to be flown into the container 36. The liquid receiving member 35 may be an open pipe.

The liquid receiving member 35 is preferably provided immediately below the area where the film 19 is cooled. As described previously, during cooling of the film 19, a large amount of portion of the film-forming plasticizer 16 is dripped from the film 19. Providing the liquid receiving member 35 immediately below the area where the film 19 is cooled allows the film-forming plasticizer 16 to be received immediately below the film 19 being cooled. This achieves an adequately high rate of collection of a used film-forming plasticizer 16.

Further, the liquid receiving member 35 is preferably provided immediately below the plasticizer separating section 8. During separation of the film-forming plasticizer 16 from the film 19, a large amount of portion of the film-forming plasticizer 16 is dripped from the film 19. Providing the liquid receiving member 35 immediately below the plasticizer separating section 8 achieves an adequately high rate of collection of a used film-forming plasticizer 16.

That is, the first plasticizer collecting section 6 illustrated in FIG. 1 is realized in the form of the container 29, whereas the first plasticizer collecting section 34 illustrated in FIG. 5 is realized in the form of a combination of the liquid receiving member 35 and the container 36. The film producing apparatus 100 may include the first plasticizer collecting section 34 in place of the first plasticizer collecting section 6.

(a) of FIG. 6 is a schematic diagram illustrating a plasticizer separating section 38.

The plasticizer separating section 38 illustrated in (a) of FIG. 6 is different from the plasticizer separating section 8 illustrated in FIG. 1 in the following points. Specifically, the plasticizer separating section 38 includes a sponge 39 and a sponge 40 both of which make contact with the film 19. On contact with the film 19, the sponge 39 and the sponge 40 each suck up a portion of the film-forming plasticizer 16 from the film 19. The sponges 39 and 40 each have pores communicating with each other. A material of the sponges 39 and 40 can be urethane rubber having a hardness of 20 to 60, polyvinyl chloride (PVC), polyvinyl alcohol (PVA), or polypropylene (PP). Each of the sponges 39 and 40 may have a flat surface for making contact with the film 19 or may be shaped in a cylinder so as to rotate and make contact with the film 19.

That is, the plasticizer separating section 8 illustrated in FIG. 1 is realized in the form of the nip rollers 32 and 33, whereas the plasticizer separating section 38 illustrated in (a) of FIG. 6 is realized in the form of the sponges 39 and 40. The film producing apparatus 100 may include the plasticizer separating section 38 in place of the plasticizer separating section 8.

(b) of FIG. 6 is a schematic diagram illustrating a plasticizer separating section 41.

The plasticizer separating section 41 illustrated in (b) of FIG. 6 is different from the plasticizer separating section 8 illustrated in FIG. 1 in the following points. Specifically, the plasticizer separating section 41 includes an air blast mechanism 42. The air blast mechanism 42 blasts air 43 toward the film 19 to blow a portion of the film-forming plasticizer 16 off the film 19.

That is, the plasticizer separating section 8 illustrated in FIG. 1 is realized in the form of the nip rollers 32 and 33, whereas the plasticizer separating section 41 illustrated in (b) of FIG. 6 is realized in the form of the air blast mechanism 42. The film producing apparatus 100 may include the plasticizer separating section 41 in place of the plasticizer separating section 8.

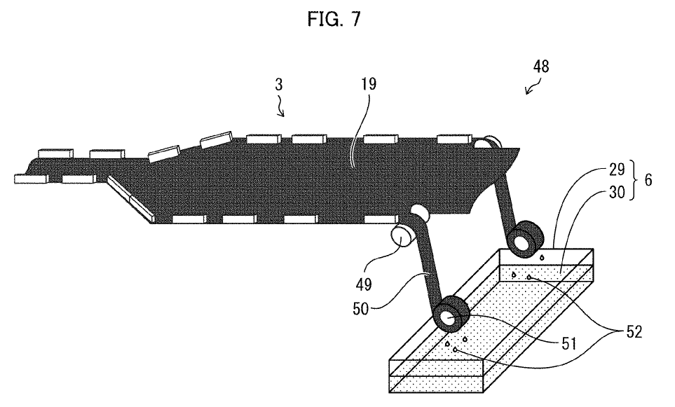

FIG. 7 is a schematic diagram illustrating a plasticizer separating section 48.

The plasticizer separating section 48 illustrated in FIG. 7 is different from the plasticizer separating section 8 illustrated in FIG. 1 in the following points. That is, the plasticizer separating section 48 includes: a slitting section 49 configured to slit the film 19 having been stretched by the stretching section 3 to cut off the end portions of the film 19 which end portions extend in the TD direction; and a slit scrap collecting section 51 configured to collect a slit scrap 50 which is caused by slitting the film 19. The slitting section 49 and the slit scrap collecting section 51 are located downstream of the stretching section 3 and upstream of the cleaning tank 25 of the cleaning section 5. The end portions of the film 19 having been stretched by the stretching section 3 which end portions extend in the TD direction are larger in thickness than a center portion of the film 19 having been stretched by the stretching section 3 which center portion extends in the TD direction, and the end portions contain a larger amount of film-forming plasticizer 16 than the center portion. Thus, it is possible to effectively collect the film-forming plasticizer 16 from the slit scrap 50. Examples of a method of collecting the film-forming plasticizer 16 from the slit scrap 50 include a method including: pressing the collected slit scrap 50 to squeeze the film-forming plasticizer 16 out of the slit scrap 50; and storing the squeezed film-forming plasticizer 16 in a container for receiving the squeezed film-forming plasticizer 16.

The slit scrap collecting section 51 is preferably such that the slit scrap 50 is wound up by, for example, a bobbin to collect the film-forming plasticizer 16. When the slit scrap 50 is wound up by, for example, a bobbin, winding of the slit scrap 50 separates the film-forming plasticizer 16 from the slit scrap 50, and thus causes drops 52 containing the film-forming plasticizer 16 to be dripped. Thus, it is preferable that a container 29 for receiving the drops 52 is provided immediately below the slit scrap collecting section 51. Providing the container 29 immediately below the slit scrap collecting section 51 achieves an increase in rate of collection of the film-forming plasticizer 16 and reduction of contamination with the film-forming plasticizer 16 in the step.

Note that the slitting section 49 can perform slitting by any of methods including generally used slit methods such as a shear cutting method and a razor cutting method.

That is, the plasticizer separating section 8 illustrated in FIG. 1 is realized in the form of nip rollers 32 and 33, while the plasticizer separating section 48 illustrated in FIG. 7 is realized in the form of a combination of the slitting section 49 and the slit scrap collecting section 51. The film producing apparatus 100 may include the plasticizer separating section 48 in place of the plasticizer separating section 8.

Note that the present invention also encompasses a film producing method using the film producing apparatus 100.

[Recap]

A film producing apparatus in accordance with an embodiment of the present invention includes: a kneading section configured to knead a polyolefin resin and a film-forming plasticizer to prepare a polyolefin resin solution; an extruding section configured to perform extrusion molding of the polyolefin resin solution thus prepared to form a film in a form of a sheet; and at least one plasticizer collecting section configured to collect a portion of the film-forming plasticizer which portion has been separated from the film.

Further, a method of producing a film in accordance with an embodiment of the present invention includes: a first kneading step including kneading a first polyolefin resin and a first film-forming plasticizer to prepare a first polyolefin resin solution; an extruding step including performing extrusion molding of the first polyolefin resin solution thus prepared to form a film in a form of a sheet; and a plasticizer collecting step including collecting a portion of the first film-forming plasticizer which portion has been separated from the film.

The above configuration allows for collection of a portion of a film-forming plasticizer which portion has been separated from a film. This makes it possible to increase a rate of collection of a used film-forming plasticizer. Consequently, the cost of producing a film can be reduced by reusing the film-forming plasticizer.

Further, a film producing apparatus in accordance with an embodiment of the present invention is preferably configured such that the plasticizer collecting section includes a first plasticizer collecting section configured to collect a portion of the film-forming plasticizer which portion has been dripped from the film.

Still further, a method of producing a film in accordance with an embodiment of the present invention is preferably such that the plasticizer collecting step includes collecting the portion of the first film-forming plasticizer which portion has been dripped from the film.

The above configuration allows for collection of a portion of a film-forming plasticizer which portion has been dripped from a film.

Further, a film producing apparatus in accordance with an embodiment of the present invention is preferably configured such that the first plasticizer collecting section includes a container for receiving the portion of the film-forming plasticizer which portion has been dripped from the film.

According to the above configuration, the first plasticizer collecting section can be realized in the form of a container.

Further, a film producing apparatus in accordance with an embodiment of the present invention is preferably configured such that the container is provided immediately below a plasticizer separating section configured to separate a portion of the film-forming plasticizer from the film and/or immediately below an area where the film is cooled.

During cooling of a film, a large amount of portion of a film-forming plasticizer can be dripped from the film. According to the above configuration, a portion of the film-forming plasticizer is received immediately below the film being cooled. This achieves an adequately high rate of collection of a used film-forming plasticizer.

Also, during separation of the film-forming plasticizer from the film, a large amount of portion of the film-forming plasticizer is dripped from the film. Providing the container immediately below the plasticizer separating section achieves an adequately high rate of collection of a used film-forming plasticizer.

Still further, a film producing apparatus in accordance with an embodiment of the present invention is preferably configured such that the first plasticizer collecting section includes: a liquid receiving member for receiving the portion of the film-forming plasticizer which portion has been dripped from the film; and a container placed in such a position that the portion of the film-forming plasticizer is flown into the container through the liquid receiving member.

According to the above configuration, the first plasticizer collecting section can be realized in the form of a combination of a liquid receiving member and a container.

Further, a film producing apparatus in accordance with an embodiment of the present invention is preferably configured such that the liquid receiving member is provided immediately below a plasticizer separating section configured to separate a portion of the film-forming plasticizer from the film and/or immediately below an area where the film is cooled.

During cooling of a film, a large amount of portion of a film-forming plasticizer can be dripped from the film. According to the above configuration, a portion of the film-forming plasticizer is received immediately below the film being cooled. This achieves an adequately high rate of collection of a used film-forming plasticizer.

Also, during separation of the film-forming plasticizer from the film, a large amount of portion of the film-forming plasticizer is dripped from the film. Providing the liquid receiving member immediately below the plasticizer separating section achieves an adequately high rate of collection of a used film-forming plasticizer.

Still further, a film producing apparatus in accordance with an embodiment of the present invention is preferably configured such that the plasticizer collecting section includes a second plasticizer collecting section configured to collect a portion of the film-forming plasticizer which portion has been volatilized from the film.

Further, a method of producing a film in accordance with an embodiment of the present invention is preferably configured such that the plasticizer collecting step includes collecting a portion of the first film-forming plasticizer which portion has been volatilized from the film.

The above configuration allows for collection of a portion of a film-forming plasticizer which portion has been volatilized from a film.

Still further, a film producing apparatus in accordance with an embodiment of the present invention is preferably configured such that the second plasticizer collecting section includes a suction port for suctioning a gas containing the portion of the film-forming plasticizer which portion has been volatilized from the film.

According to the above configuration, the second plasticizer collecting section can be realized in the form of a suction port.

Further, a method of producing a film in accordance with an embodiment of the present invention preferably further includes: a second kneading step including kneading a second polyolefin resin, the portion of the first film-forming plasticizer which portion has been collected in the plasticizer collecting step, and a second film-forming plasticizer to prepare a second polyolefin resin solution.

According to the above configuration, the cost of producing a film can be reduced by reusing the film-forming plasticizer.

Further, embodiments of the present invention can also be expressed as below.

That is, a film producing method in accordance with an embodiment of the present invention includes: a first kneading step of kneading a polyolefin resin and a first film-forming plasticizer to prepare a first polyolefin resin solution; an extruding step of performing extrusion molding of the first polyolefin resin solution thus prepared to form a film in a form of a sheet; and a plasticizer collecting step of collecting a portion of the first film-forming plasticizer which portion has been separated from the film.

Further, a film producing method in accordance with an embodiment of the present invention is such that the plasticizer collecting step collects a portion of the first film-forming plasticizer which portion has been dripped from the film.

Still further, a film producing method in accordance with an embodiment of the present invention is such that the plasticizer collecting step collects a portion of the first film-forming plasticizer which portion has been volatilized from the film.

Further, a film producing method in accordance with an embodiment of the present invention further includes: a second kneading step of kneading a polyolefin resin, the portion of the first film-forming plasticizer which portion has been collected in the plasticizer collecting step, and a second film-forming plasticizer to prepare a second polyolefin resin solution.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1: Kneading section

2: Extruding section

3: Stretching section

4: Conveying section

5: Cleaning section

6: First plasticizer collecting section

7: Second plasticizer collecting section

8: Plasticizer separating section

15: Polyolefin resin (first polyolefin resin)

16: Film-forming plasticizer

17: Polyolefin resin solution (first polyolefin resin solution)

19: Film

29: Container

31: Suction port

32: Nip roller

33: Nip roller

34: First plasticizer collecting section

35: Liquid receiving member

36: Container

38: Plasticizer separating section

39: Sponge

40: Sponge

41: Plasticizer separating section

42: Air blast mechanism

43: Air

48: Plasticizer separating section

49: Slitting section

51: Slit scrap collecting section

100: Film producing apparatus

1. A film producing apparatus comprising:
a kneading section configured to knead a polyolefin resin and a film-forming plasticizer to prepare a polyolefin resin solution;
an extruding section configured to perform extrusion molding of the polyolefin resin solution thus prepared to form a film in a form of a sheet; and
at least one plasticizer collecting section configured to collect a portion of the film-forming plasticizer which portion has been separated from the film.

2. The film producing apparatus according to claim 1, wherein the plasticizer collecting section includes a first plasticizer collecting section configured to collect a portion of the film-forming plasticizer which portion has been dripped from the film.

3. The film producing apparatus according to claim 2, wherein the first plasticizer collecting section includes a container for receiving the portion of the film-forming plasticizer which portion has been dripped from the film.

4. The film producing apparatus according to claim 3, wherein the container is provided immediately below a plasticizer separating section configured to separate a portion of the film-forming plasticizer from the film and/or immediately below an area where the film is cooled.

5. The film producing apparatus according to claim 2, wherein the first plasticizer collecting section includes:
a liquid receiving member for receiving the portion of the film-forming plasticizer which portion has been dripped from the film; and
a container placed in such a position that the portion of the film-forming plasticizer is flown into the container through the liquid receiving member.

6. The film producing apparatus according to claim 5, wherein the liquid receiving member is provided immediately below a plasticizer separating section configured to separate a portion of the film-forming plasticizer from the film and/or immediately below an area where the film is cooled.

7. The film producing apparatus according to claim 1, wherein the plasticizer collecting section includes a second plasticizer collecting section configured to collect a portion of the film-forming plasticizer which portion has been volatilized from the film.

8. The film producing apparatus according to claim 7, wherein the second plasticizer collecting section includes a suction port for suctioning a gas containing the portion of the film-forming plasticizer which portion has been volatilized from the film.

9. A method of producing a film comprising:
a first kneading step comprising kneading a first polyolefin resin and a first film-forming plasticizer to prepare a first polyolefin resin solution;
an extruding step comprising performing extrusion molding of the first polyolefin resin solution thus prepared to form a film in a form of a sheet; and
a plasticizer collecting step comprising collecting a portion of the first film-forming plasticizer which portion has been separated from the film.

10. The method of producing a film according to claim 9, wherein the plasticizer collecting step comprises collecting a portion of the first film-forming plasticizer which portion has been dripped from the film.

11. The method of producing a film according to claim 9, wherein the plasticizer collecting step comprises collecting a portion of the first film-forming plasticizer which portion has been volatilized from the film.

12. The method of producing a film according to claim 9, further comprising:
a second kneading step comprising kneading a second polyolefin resin, the portion of the first film-forming plasticizer which portion has been collected in the plasticizer collecting step, and a second film-forming plasticizer to prepare a second polyolefin resin solution.
